(19) United States
(12) Patent Application Publication
(10) Pub. No.: US 2007/0209644 A1
(43) Pub. Date: Sep. 13, 2007

(54) Charge air heater

(76) Inventor: Gilberto Abu Gannam, Claudia-Santos Reis-Piracaia (BR)

Correspondence Address: NOTARO AND MICHALOS, 100 DUTCH HILL ROAD, SUITE 110, ORANGEBURG, NY, 10962-2100, US

(21) Appl. No.: 11/706,084

(22) Filed: Feb. 13, 2007

(30) Foreign Application Priority Data
Mar. 13, 2006 (BR) PI0600883-6

(51) Int. Cl. F02G 5/00

(52) U.S. Cl. 123/556

(57) ABSTRACT

The objective of the present invention is a charge air heater belonging to the field of vehicle equipment, which was developed to have a simple system for gasifying fuels and, in this manner, increase the efficiency and yield of internal combustion engines. It is made up of a tee (1) that connects an insulated or non-insulated tube from an adaptable part (5) to the inlet tube (6) or is connected directly to it, causing the hot gases present in the head—that is interconnected to the engine crankcase—to also be suctioned by the engine, heating the air in the inlet tube (6) even more with turbulent movement, increasing the combustion yield and engine efficiency.

### FIELD AND BACKGROUND OF THE INVENTION

The objective of this invention patent is a charge air heater belonging to the field of vehicle equipment, which was developed to have a simple system for gasifying fuels and, in this manner, increase the efficiency and yield of internal combustion engines.

According to the technical know-how, the internal combustion engines perform their work burning a mixture of fuel vapor and air inside a cylinder. When this mixture burns, hot gases are formed, which expand quickly and pushes the internal engine parts causing its movement.

However, in the currently used engines it is observed that the burning efficiency is not complete due to the fact that part of the fuel is not being vaporized and, therefore, does not burn all the fuel, generating NOx and soot that are deposited in the exhaust and goes into the atmosphere, thereby polluting the environment.

### SUMMARY OF THE INVENTION

Contemplating on solving such inconveniences, the inventor idealized and built a charge air heater that is the object of the present unexamined patent application, comprising a tee that connects an insulated or non-insulated tube from an adaptable part to the inlet tube or directly connected to it, causing the hot gases present in the head—which is interconnected to the engine crankcase—to also be suctioned by the engine, heating the air in the inlet tubes even more.

Such construction results in a system where there is turbulent air movement that, in addition to using the heat from gases in the head, it also removes heat from the water around the inlet tubes, with greater efficiency due to the increase in peripheral speed of air, in the tube. This heating improves the yield of combustion, improving gasification of injected fuel resulting in a quicker and more efficient combustion. This improvement is not only from the better gasification of fuel but also—and mainly—from the increased turbulence during combustion, resulting in significant reduction of release of pollutants into the atmosphere.

For better understanding, the object of the present application will be better written and illustrated based on the attached drawings in which:

### BRIEF DESCRIPTION OF THE DRAWINGS

FIG. 1 constitutes of an assembled set that is ready for use;

FIG. 2 corresponds to the upper view of the part to be adapted after the throttle body of the set, and

FIG. 3 corresponds to an alternative construction method, with connection made directly to the inlet tube soon after the throttle body.

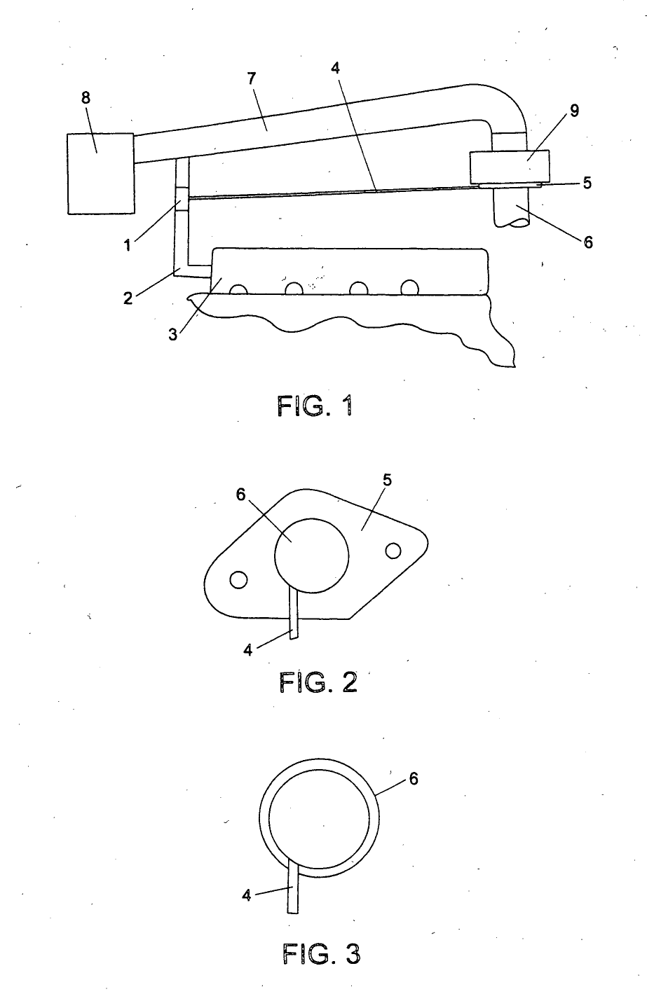

### DESCRIPTION OF THE PREFERRED EMBODIMENTS

In accordance with how much the aforementioned drawings are illustrated, the referred charge air heater object of the present patent invention application is made up of: a tee (1) installed in the conduit (2) coming from the head cover (3), from which an insulated or non-insulated tube comes out (4), which connects to an intermediary part (5) or is embedded directly to the engine inlet tube (6).

The tube (2) in the current engines—which corresponds to the head breather—connects the head cover (3) to a conduit (7) that has one of its ends connected to the engine charge air filter box (8) and which takes the filtered air to the throttle body (9) on which the intermediary part can be installed (5). The tube (4) connects the head breather (2) to the engine inlet tube (6), able to be connected to the part placed after the throttle body (5) not perpendicular to the tube shaft (6) or the part (5) in a manner that forces air turbulence in the tube wall, removing heat on passing through the inlet tubes (6), which are with circulation water connected to the radiator. In this manner, the hot gases present in the head are also suctioned by the engine, passing through the tube (4) and moving to the inlet tube (6). As the entry into the tube (6) is not perpendicular to the tube shaft, and enters between the center of the tube and its wall—as can be observed in FIGS. 2 and 3, there is a turbulent movement that uses the heat from head gases and removes the heat from the water around the inlet tubes (6), increasing the engine efficiency.

It should be emphasized that the presented figures illustrate in a preferential but non-limiting manner of construction, able to be carried out in other different forms without escaping from the scope of intended protection—engine charge air heating for greater combustion efficiency and yield.

Therefore, corollary of the shown and illustrated, it can be seen that the CHARGE AIR HEATER plainly meets the requirements necessary for obtaining Invention Patent registration claimed herein.

1. “CHARGE AIR HEATER”, characterized by a tee (1) installed in the conduit (2) coming from the head cover (3), from which an insulated or non-insulated tube comes out (4) that is connected to an intermediary part (5) or is embedded directly on the engine inlet tube wall (6).

2. “CHARGE AIR HEATER”, in accordance with claim 1, characterized by the fact that the tube (4) connects the head breather (2) to the intermediary part (5) in a non-perpendicular manner to the tube shaft (6), removing heat on passing through the inlet tubes (6), which are with circulation water connected to the radiator.

3. “CHARGE AIR HEATER”, in accordance with claim 1, characterized by the fact that the tube (4) can be embedded directly on the engine inlet tube wall (6).
